(19) United States
(12) Patent Application Publication
(10) Pub. No.: US 2016/0135215 A1
(43) Pub. Date: May 12, 2016

(54) LONG TERM EVOLUTION NETWORK SYSTEM AND DATA TRANSMISSION SCHEDULING METHOD THEREOF

(71) Applicant: Institute For Information Industry, Taipei (TW)

(72) Inventors: Chia-Hung Wei, Taipei City (TW); Feng-Ming Yang, Taipei City (TW)

(21) Appl. No.: 14/929,956

(22) Filed: Nov. 2, 2015

Related U.S. Application Data
(60) Provisional application No. 62/077,161, filed on Nov. 7, 2014.

(51) Int. Cl. H04W 72/12; H04W 56/00; H04W 52/02; H04W 76/04

(52) U.S. Cl. CPC H04W 72/1289; H04W 76/048; H04W 56/0015; H04W 52/0206

(57) ABSTRACT

An LTE network system and a data transmission scheduling method thereof are provided. The LTE network system includes a first base station and a mobile station. The mobile station connects with the first base station and a second base station. A first base station data processing module of the mobile station processes data transmitted from the first base station, and a second base station data processing module of the mobile station processes data transmitted from the second base station. The first base station transmits a data transmission time of first data control information to the second base station, and transmits the first data control information to the mobile station. The first base station data processing module notifies the second base station data processing module of the data transmission time of the first data control information. The second base station data processing module sets a base station listening status as active.

### PRIORITY

This application claims priority to U.S. Provisional Patent Application No. 62/077,161 filed on Nov. 7, 2014, which is hereby incorporated by reference in its entirety.

### FIELD

The present invention relates to a Long Term Evolution (LTE) network system and a data transmission scheduling method thereof. More particularly, the present invention relates to a dual connectivity LTE network system and a data transmission scheduling method thereof.

### BACKGROUND

In the conventional LTE network system, a mobile station may have the functionality of dual connectivity. Briefly speaking, the mobile station may connect to two base stations at the same time and use two connection modules to transmit data with the two base stations respectively. In this case, data transmissions of the two connection modules of the mobile station with the two base stations must be performed within respective data transmission periods of the two base stations.

To maintain the efficiency of the power saving function of the mobile station, usually calibration of data transmission periods must be firstly made for the mobile station between the base stations so that the wake-up periods and the sleep periods of the two connection modules of the mobile station are the same as each other to avoid increase of the overall wake-up time of the mobile station due to differences of the aforesaid periods.

However, in the current technologies, there is a case where when the two connection modules of the mobile station have the same wake-up periods and sleep periods with respect to the two base stations but one of the connection modules transmits data with its corresponding base station while the other connection module does not transmit data with its corresponding base station, the other connection module still enters into the sleep period directly when a wake-up time thereof is over. That is, one of the connection modules is idle in the wake-up period while the mobile station as a whole is in a power consumption status of data transmission. This degrades the resource utilization efficiency and may make it impossible to further improve the power saving effect.

Accordingly, an urgent need exists in the art to improve the shortcomings of the data transmission scheduling of the conventional LTE network system so as to increase the resource utilization efficiency and further improve the power saving effect.

### SUMMARY

The disclosure includes a data transmission scheduling method for a Long Term Evolution (LTE) network system. The LTE network system comprises a first base station and a mobile station. The mobile station connects with the first base station and a second base station. A first base station data processing module of the mobile station processes data transmitted from the first base station, and a second base station data processing module of the mobile station processes data transmitted from the second base station. The data transmission scheduling method comprises the following steps of: (a) enabling the first base station to transmit a data transmission time of first data control information to the second base station; (b) enabling the first base station to transmit the first data control information to the mobile station; (c) enabling the first base station data processing module of the mobile station to notify the second base station data processing module of the data transmission time of the first data control information; and (d) enabling the second base station data processing module of the mobile station to set a base station listening status of the second base station data processing module as active according to the data transmission time.

The disclosure includes an LTE network system, which comprises a first base station and a mobile station. The mobile station connects with the first base station and a second base station, and comprises: a first base station data processing module, being configured to process data transmitted from the first base station; and a second base station data processing module, being configured to process data transmitted from the second base station. The first base station transmits a data transmission time of first data control information to the second base station and transmits the first data control information to the mobile station. The first base station data processing module notifies the second base station data processing module of the data transmission time of the first data control information. The second base station data processing module sets a base station listening status of the second base station data processing module as active according to the data transmission time.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIGS. 1A˜1B are schematic views of an LTE network system according to a first embodiment of the present invention;

FIG. 2 is a schematic view of an LTE network system according to a second embodiment of the present invention;

FIG. 3A is a schematic view of an LTE network system according to a third embodiment of the present invention;

FIG. 3B is a schematic view illustrating signal transmission periods in the LTE network system according to the third embodiment of the present invention;

FIG. 3C is another schematic view illustrating signal transmission periods in the LTE network system according to the third embodiment of the present invention;

FIG. 4 is a flowchart diagram of a data transmission scheduling method according to a fourth embodiment of the present invention; and

FIG. 5 is a flowchart diagram of a data transmission scheduling method according to a fifth embodiment of the present invention.

### DETAILED DESCRIPTION

In the following description, the present invention will be explained with reference to example embodiments thereof. However, these example embodiments are not intended to limit the present invention to any specific examples, embodiments, environment, applications or particular implementations described in these example embodiments. Therefore, description of these example embodiments is only for purpose of illustration rather than to limit the present invention. In the following example embodiments and the attached drawings, elements unrelated to the present invention are omitted from depiction; and dimensional relationships among individual elements in the attached drawings are illustrated only for ease of understanding, but not to limit the actual scale.

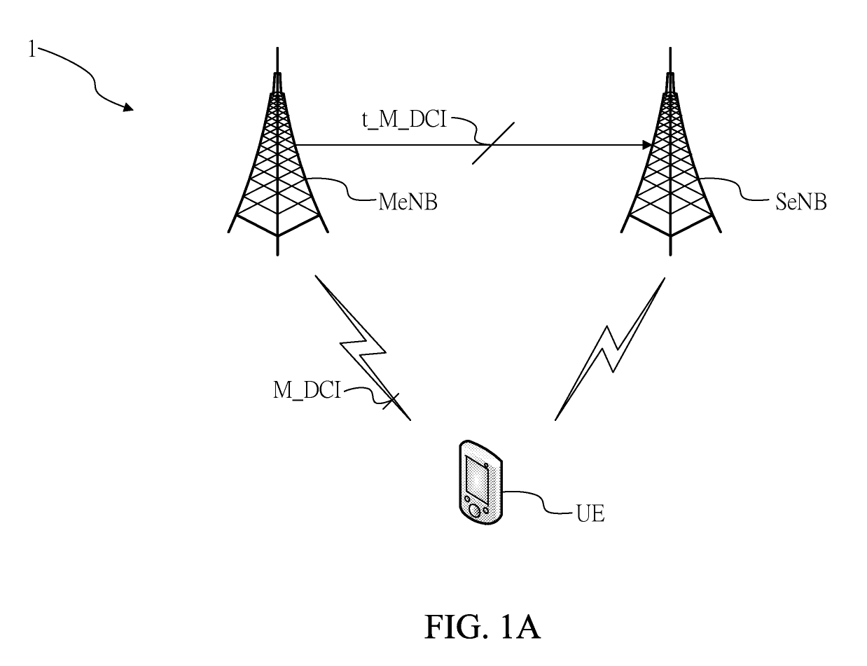

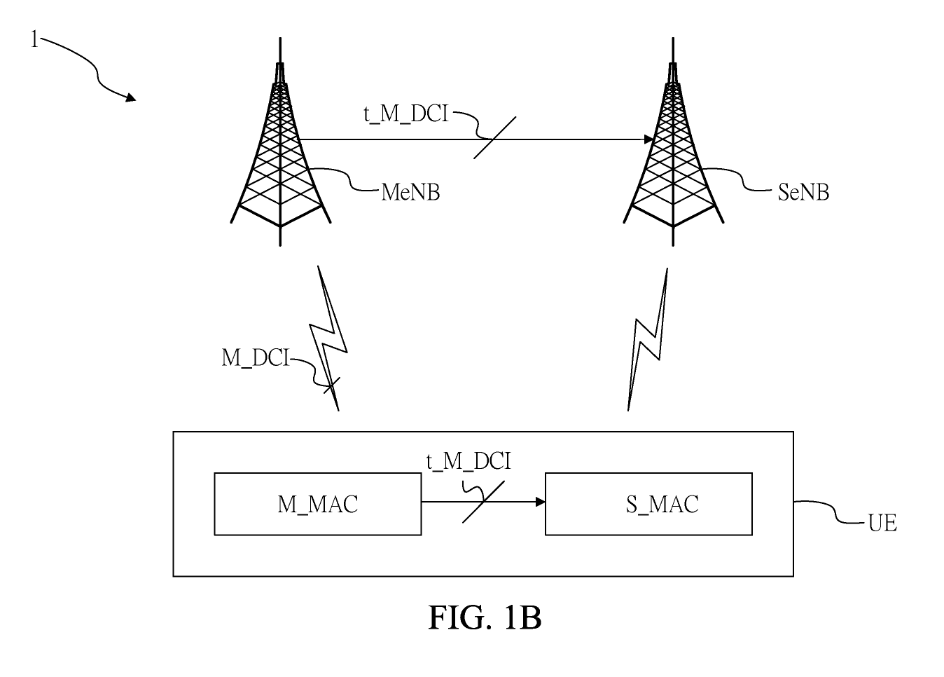

Please refer to FIGS. 1A˜1B, which are schematic views of an LTE network system 1 according to a first embodiment of the present invention. The LTE network system 1 comprises a first base station MeNB and a mobile station UE. The mobile station UE comprises a first base station data processing module M_MAC and a second base station data processing module S_MAC. The first base station data processing module M_MAC processes data transmitted by the first base station MeNB, and the second base station data processing module S_MAC processes data transmitted by the second base station SeNB. Interactions of the LTE network system 1 and devices thereof will be further described herein.

First, when the first base station MeNB is to transmit first data control information M_DCI (e.g., including wireless resource block scheduling information that instructs the mobile station to receive data at a specific time and a specific frequency) to the mobile station UE in a data transmission period, the first base station MeNB firstly transmits a data transmission time t_M_DCI of the first data control information M_DCI to the second base station SeNB so as to notify the second base station SeNB of the time during which the first base station MeNB will subsequently transmit data.

Next, the first base station MeNB transmits the first data control information M_DCI to the mobile station UE. Then, the first base station data processing module M_MAC of the mobile station UE firstly notifies the second base station data processing module S_MAC of the data transmission time t_M_DCI of the first data control information M_DCI so that the second base station data processing module S_MAC can predict a time during which the first base station data processing module M_MAC will stay in a wake-up status for data processing.

Therefore, the second base station data processing module S_MAC can set the base station listening status of the second base station data processing module S_MAC as active according to the data transmission time t_M_DCI. In other words, the second base station data processing module S_MAC will set its own status as a wake-up status at the time during which the first base station data processing module M_MAC will stay in the wake-up statue for data processing according to the data transmission time t_M_DCI.

Accordingly, the second base station data processing module S_MAC can try to transmit data, in a wake-up status, with the second base station SeNB when the first base station MeNB is transmitting data with the first base station data processing module M_MAC during the data transmission time t_M_DCI. Thus, when the mobile station UE as a whole is in a wake-up status because of the data transmission being performed between the first base station data processing module M_MAC and the first base station MeNB, the second base station data processing module S_MAC may be waken up to try data transmissions with the second SeNB. This can increase the resource utilization efficiency of the mobile station UE as a whole and further improves the power saving effect.

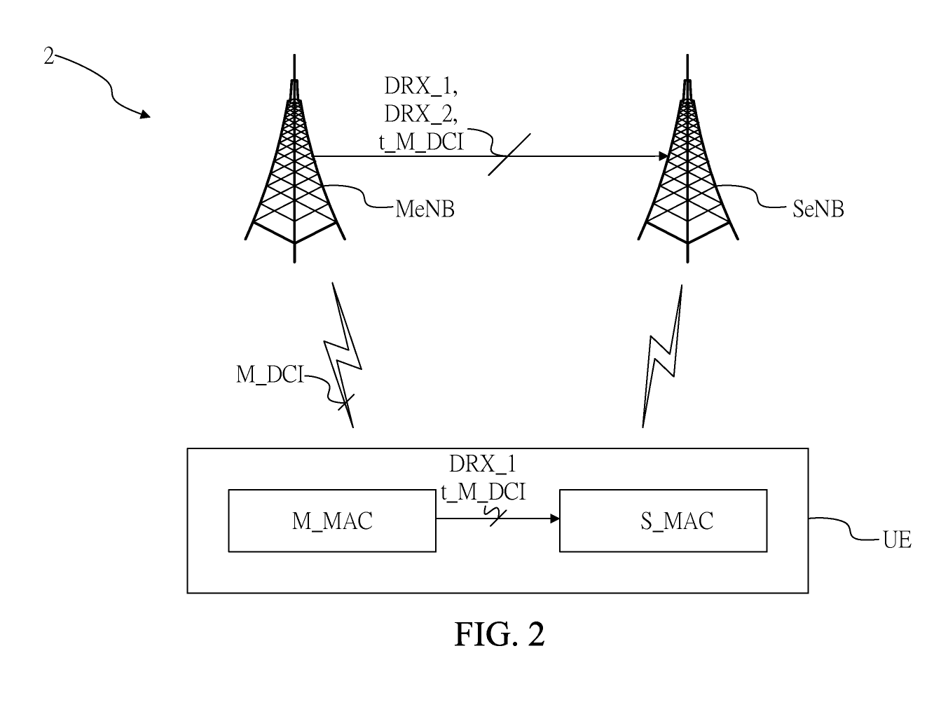

Please refer to FIG. 2, which is a schematic view of an LTE network system 2 according to a second embodiment of the present invention. The framework of the second embodiment is similar to that of the first embodiment, so elements bearing the same reference numerals also have the same functions and will not be further described herein. The second embodiment mainly describes the scheduling technology for the second base station data processing module S_MAC of the mobile station UE in more detail.

In particular, in the second embodiment, the first base station MeNB mainly utilizes a first discontinuous reception (DRX) configuration DRX_1 to transmit data to the first base station data processing module M_MAC of the mobile station UE, and the second base station SeNB mainly utilizes a second DRX configuration DRX_2 to transmit data to the second base station data processing module S_MAC of the mobile station UE.

The first base station data processing module M_MAC of the mobile station UE notifies the second base station data processing module S_MAC of the first DRX configuration DRX_1 so as to inform the second base station data processing module S_MAC of the time period during which the first base station data processing module M_MAC will subsequently transmit data with the first base station MeNB.

Similarly, when the first base station MeNB is to transmit the first data control information M_DCI to the mobile station UE in a data transmission period, the first base station MeNB firstly transmits the data transmission time t_M_DCI of the first data control information M_DCI to the second base station SeNB so as to notify the second base station SeNB of the time during which the first base station MeNB will subsequently transmit data to facilitate the second base station SeNB in determining whether to transmit data to the mobile station UE at the same time.

After the first base station MeNB has transmitted the first data control information M_DCI to the mobile station UE, the first base station data processing module M_MAC of the mobile station UE firstly notifies the second base station data processing module S_MAC of the data transmission time t_M_DCI of the first data control information M_DCI so as to notify the second base station data processing module S_MAC of the time during which the first base station data processing module M_MAC will subsequently stay in the wake-up status for data processing.

Accordingly, the second base station data processing module S_MAC can predict a time during which the first base station data processing module M_MAC will subsequently stay in the wake-up status according to the data transmission time t_M_DCI, and sets the base station listening status of the second base station data processing module S_MAC as active. In other words, the second base station data processing module S_MAC sets its own status as the wake-up status at the time during which the first base station MeNB will transmit the first data control information M_DCI according to the data transmission time t_M_DCI and the first DRX configuration DRX_1.

Accordingly, when the first base station MeNB transmits data with the first base station data processing module M_MAC during the data transmission time t_M_DCI, the second base station data processing module S_MAC can try to transmit data in a wake-up status with the second base station SeNB in the same period as the first DRX configuration DRX_1.

On the other hand, when the second base station SeNB determines according to the data transmission time t_M_DCI that data may be transmitted at the same time, the second base station SeNB can transmit data to the second base station data processing module S_MAC of the mobile station UE accordingly to facilitate the second base station data processing module S_MAC of the mobile station UE in receiving data from the second base station SeNB according to the wake-up status described in the aforesaid step.

Thereby, when the mobile station UE as a whole stays in a wake-up status because of data transmissions between the first base station data processing module M_MAC and the first base station MeNB according to the first DRX configuration DRX_1, the second base station data processing module S_MAC is waken up to try to transmit data with the second base station SeNB according to also the first DRX configuration DRX_1, thus further increasing the overall resource utilization efficiency of the mobile station UE.

It shall be particularly noted that, apart from entering into the wake-up status according to the data transmission time t_M_DCI and the first DRX configuration DRX_1, the second base station data processing module S_MAC can also enter into the wake-up status according to the second DRX configuration DRX_2 for the second base station SeNB. This will be readily appreciated by those skilled in the art and will not be further described herein.

Additionally, in the aforesaid embodiment, the base stations can exchange data therebetween via an X2 interface. In other words, the first base station MeNB may transmit the first DRX configuration DRX_1 and the data transmission time t_M_DCI to the second base station SeNB via the X2 interface, and the second base station SeNB may also transmit the second DRX configuration DRX_2 to the first base station MeNB. Similarly, in cases where the base stations connect with each other via a backhaul connection, data may be exchanged via an S1 interface between the respective base station and the core network. On the other hand, the base stations may transmit data to the mobile station via a physical downlink control channel, i.e., the first base station MeNB may transmit the first data control information M_DCI to the mobile station UE via the physical downlink control channel.

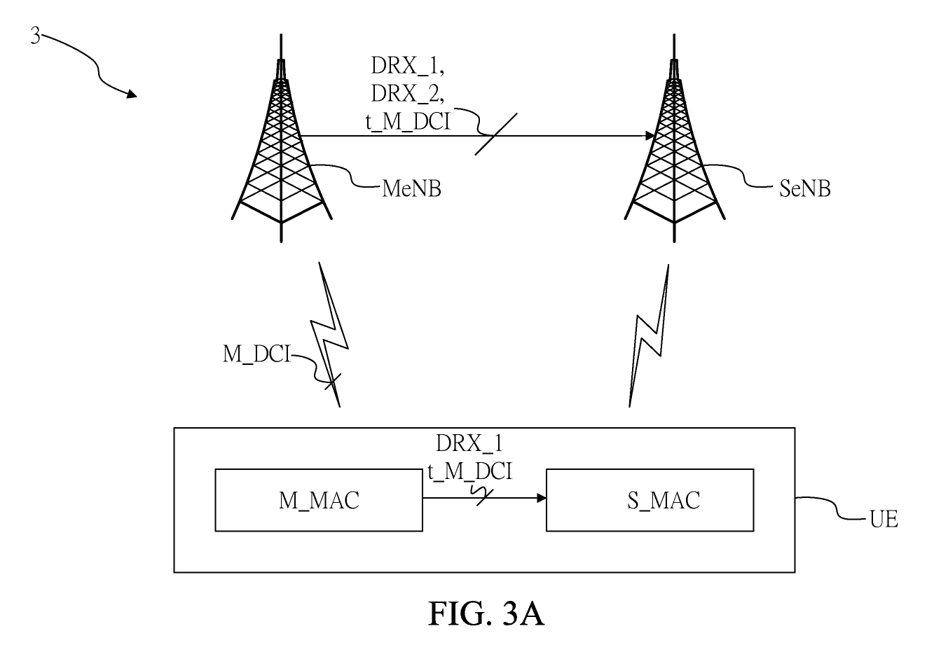

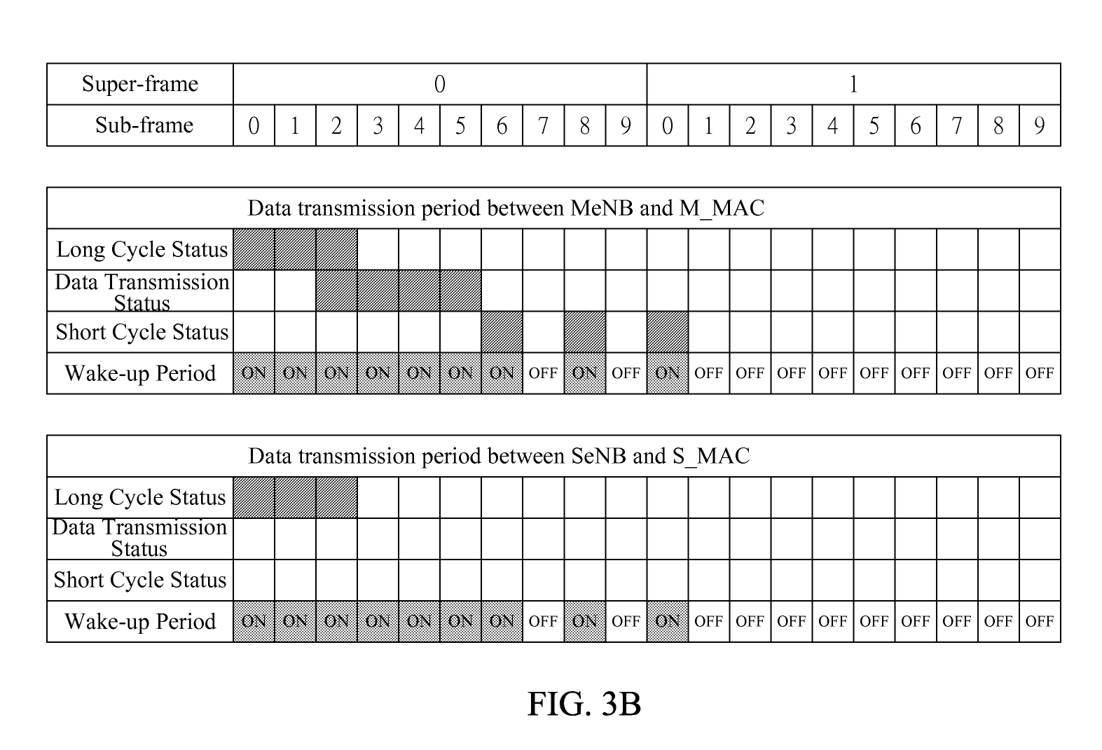

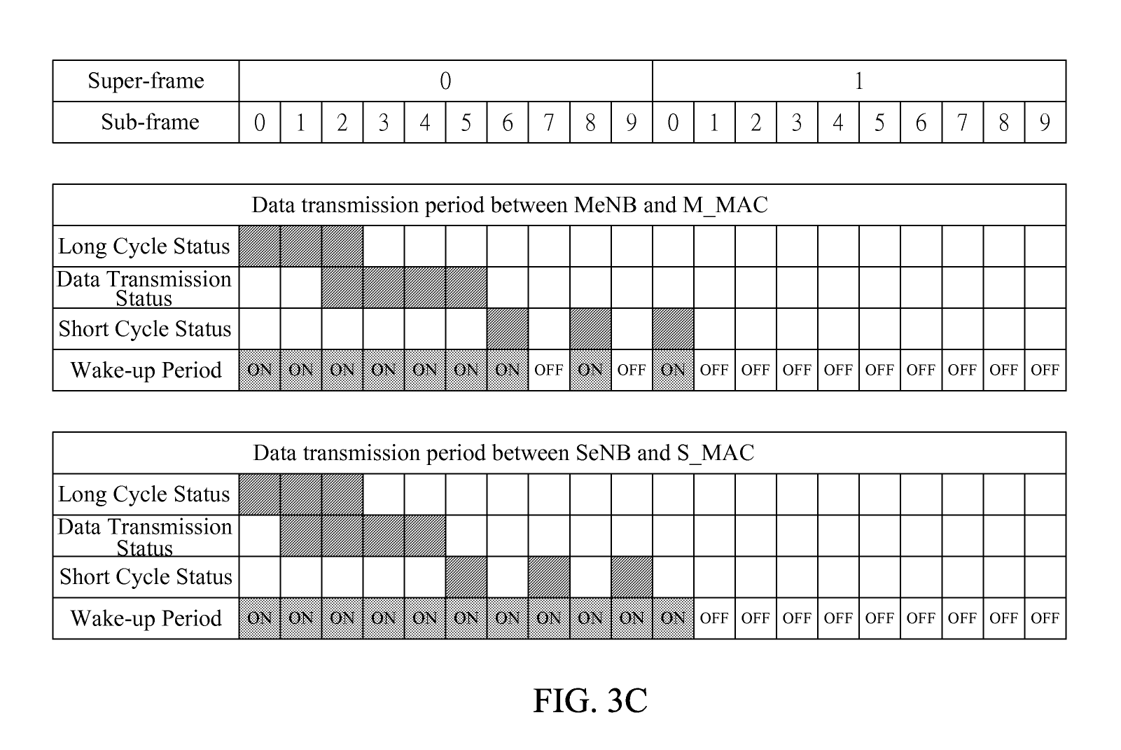

Please refer next to FIGS. 3A˜3B. FIG. 3A is a schematic view of an LTE network system 3 according to a third embodiment of the present invention, and FIG. 3B is a schematic view illustrating signal transmission periods in the LTE network system 3 according to the third embodiment of the present invention. The framework of the third embodiment is similar to that of the previous embodiments, so elements bearing the same reference numerals also have the same functions and will not be further described herein. The third embodiment mainly illustrates the scheduling technology of the present invention in more detail in terms of signal transmission periods.

In the third embodiment, a super-frame transmitted between devices has ten sub-frames, and parameter values of the first DRX configuration DRX_1 are as follows:

Long Cycle parameter=20, which means that the total data transmission cycle between a base station and a corresponding base station data processing module is equal to 20 sub-frames;

ON Duration Timer parameter=3, which means that the ON Duration is equal to 3 sub-frames;

Long Cycle Offset parameter=(20, 0), which means that among the 20 sub-frames of the Long Cycle, the 3 sub-frames of the ON Duration Timer starts from the 0^{th} position;

Inactive Timer parameter=4, which means that a wake-up status lasting for 4 sub-frames will be maintained when there is a data transmission;

Short Cycle parameter=2, which means that the Short Cycle is equal to 2 sub-frames; and

Short Cycle Timer parameter=3, which means that the short cycle is repeated thrice.

As shown, when the first base station MeNB is scheduled to transmit the first data control information M_DCI to the first base station data transmission module M_MAC in the third sub-frame (i.e., Sub-frame 2), the timer will be activated to wake up for four sub-frames. After the data transmission is completed, there come the two sub-frames of the short cycle, of which one is in the wake-up status and the other is in the sleep status, and the short cycle is repeated thrice. Thus, there will be a wake-up period pattern between the first base station MeNB and the first base station data transmission module M_MAC.

Because the first DRX configuration DRX_1 (including all parameters thereof) and the data transmission time t_M_DCI of the first data control information M_DCI have already been known to the second base station data processing module S_MAC, the second base station data processing module S_MAC can determine that there is a same wake-up period pattern and sets the base station listening status of the second base station data processing module S_MAC as active.

Accordingly, when a data transmission is performed between the first base station MeNB and the first base station data processing module M_MAC during the data transmission time t_M_DCI, the second base station data processing module S_MAC may be waked up in the same wake-up period pattern to try to receive data from the second base station SeNB.

Similarly, when the second base station SeNB determines that data can be transmitted at the same time according to the data transmission time t_M_DCI, the second base station SeNB can transmit data to the second base station data processing module S_MAC of the mobile station UE accordingly so as to facilitate the second base station data processing module S_MAC of the mobile station UE in receiving data from the second base station SeNB according to the wake-up status described in the aforesaid step.

Please further refer to FIG. 3C, which is another schematic view illustrating signal transmission periods in the LTE network system 3 according to the third embodiment of the present invention. Specifically, if scheduling data is transmitted from the second base station SeNB to the mobile station UE in advance, then the second base station data processing module S_MAC can not only enter into the wake-up status according to the data transmission time t_M_DCI and the first DRX configuration DRX_1, but also enter into the wake-up status according to the second DRX configuration DRX_2 for the second base station SeNB (as shown).

It shall be particularly noted that, the first base station data processing module M_MAC and the second base station data processing module S_MAC of the mobile station UE in the aforesaid embodiments may be implemented by hardware circuits such as processors and transceivers, and frameworks thereof will be readily appreciated by those skilled in the art from the above descriptions. However, this is not intended to limit implementations of the present invention.

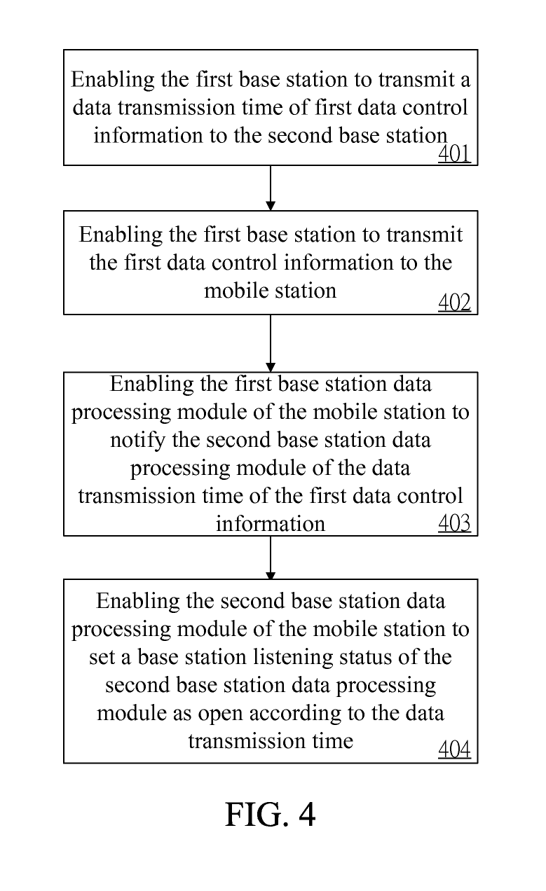

A fourth embodiment of the present invention is a data transmission scheduling method, a flowchart diagram of which is shown in FIG. 4. The method of the fourth embodiment is for use in an LTE network system (e.g., the LTE network system of one of the aforesaid embodiments) comprising a first base station and a mobile station. The mobile station connects with the first base station and a second base station. A first base station data processing module of the mobile station processes data transmitted from the first base station, and a second base station data processing module of the mobile station processes data transmitted from the second base station. Detailed steps of the fourth embodiment are described as follows.

First, step 401 is executed to enable the first base station to transmit a data transmission time of first data control information to the second base station. Step 402 is executed to enable the first base station to transmit the first data control information to the mobile station. Step 403 is executed to enable the first base station data processing module of the mobile station to notify the second base station data processing module of the data transmission time of the first data control information. Finally, step 404 is executed to enable the second base station data processing module of the mobile station to set a base station listening status of the second base station data processing module as active according to the data transmission time.

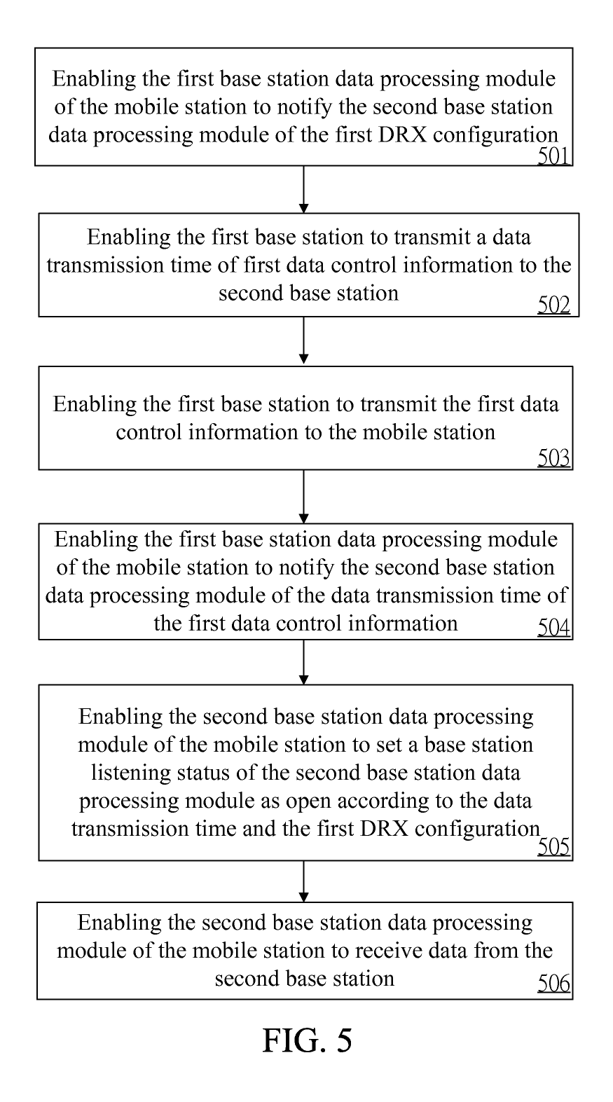

A fifth embodiment of the present invention is a data transmission scheduling method, a flowchart diagram of which is shown in FIG. 5. The method of the fifth embodiment is for use in an LTE network system (e.g., the LTE network system of one of the aforesaid embodiments) comprising a first base station and a mobile station. The mobile station connects with the first base station and a second base station. A first base station data processing module of the mobile station processes data transmitted from the first base station, and a second base station data processing module of the mobile station processes data transmitted from the second base station. The first base station utilizes a first DRX configuration to transmit data to the first base station data processing module of the mobile station. Detailed steps of the fifth embodiment are described as follows.

First, step 501 is executed to enable the first base station data processing module of the mobile station to notify the second base station data processing module of the first DRX configuration. Step 502 is executed to enable the first base station to transmit a data transmission time of first data control information to the second base station. Step 503 is executed to enable the first base station to transmit the first data control information to the mobile station.

Then step 504 is executed to enable the first base station data processing module of the mobile station to notify the second base station data processing module of the data transmission time of the first data control information. Step 505 is executed to enable the second base station data processing module of the mobile station to set a base station listening status of the second base station data processing module as active according to the data transmission time and the first DRX configuration. Finally, while the second base station is transmitting data to the mobile station according to the data transmission time of the first data control information, step 506 is executed to enable the second base station data processing module of the mobile station to receive data from the second base station according to the result of the step 505.

According to the above descriptions, the LTE network system and the data transmission scheduling method thereof according to the present invention allow the different modules of the mobile station which is in a dual connectivity mode to exchange data transmission times and DRX configurations with each other so that one of the modules originally in a sleep status can enter into a wake-up status according to the wake-up mode of the other module to try to receive data from the corresponding base station. Thereby, improvement can be made on the shortcoming of data transmission scheduling in the conventional LTE network system to increase the resource utilization efficiency and to further improve the power saving effect.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data transmission scheduling method for a Long Term Evolution (LTE) network system, the LTE network system comprising a first base station and a mobile station, the mobile station connecting with the first base station and a second base station, a first base station data processing module of the mobile station processing data transmitted from the first base station, and a second base station data processing module of the mobile station processing data transmitted from the second base station, the data transmission scheduling method comprising:
(a) the first base station transmitting a data transmission time of first data control information to the second base station;
(b) the first base station transmitting the first data control information to the mobile station;
(c) the first base station data processing module of the mobile station notifying the second base station data processing module of the data transmission time of the first data control information; and
(d) the second base station data processing module of the mobile station setting a base station listening status of the second base station data processing module as active according to the data transmission time.

2. The data transmission scheduling method of claim 1, wherein the first base station utilizes a first discontinuous reception (DRX) configuration to transmit data to the first base station data processing module of the mobile station, the method further comprising the following before the step (a):
(a1) the first base station data processing module of the mobile station notifying the second base station data processing module of the first DRX configuration;
wherein the step (d) further comprises:
(d1) the second base station data processing module of the mobile station setting the base station listening status of the second base station data processing module as active according to the data transmission time and the first DRX configuration.

3. The data transmission scheduling method of claim 1, further comprising the following step after the step (d):
(e) the second base station data processing module of the mobile station receiving data from the second base station according to the result of the step (d).

4. The data transmission scheduling method of claim 1, wherein the first base station transmits the data transmission time of the first data control information to the second base station via an X2 interface.

5. The data transmission scheduling method of claim 1, wherein the first base station transmits the first data control information to the mobile station via a physical downlink control channel.

6. An LTE network system, comprising:
a first base station; and
a mobile station, connecting with the first base station and a second base station, and comprising:
a first base station data processing module, being configured to process data transmitted from the first base station; and
a second base station data processing module, being configured to process data transmitted from the second base station,
wherein the first base station transmits a data transmission time of first data control information to the second base station and transmits the first data control information to the mobile station, the first base station data processing module notifies the second base station data processing module of the data transmission time of the first data control information, and the second base station data processing module sets a base station listening status of the second base station data processing module as active according to the data transmission time.

7. The LTE network system of claim 6, wherein the first base station utilizes a first discontinuous reception (DRX) configuration to transmit data to the first base station data processing module of the mobile station, the first base station data processing module notifies the second base station data processing module of the first DRX configuration, and the second base station data processing module sets the base station listening status of the second base station data processing module as active according to the data transmission time and the first DRX configuration.

8. The LTE network system of claim 6, wherein the second base station data processing module further receives data from the second base station according to the result of that the base station listening status is set as active.

9. The LTE network system of claim 6, wherein the first base station transmits the data transmission time of the first data control information to the second base station via an X2 interface.

10. The LTE network system of claim 6, wherein the first base station transmits the first data control information to the mobile station via a physical downlink control channel.

11. A data transmission scheduling method for a mobile station, the mobile station being used in an LTE network system, the LTE network system further comprising a first base station, the mobile station connecting with the first base station and a second base station, a first base station data processing module of the mobile station processing data transmitted from the first base station, and a second base station data processing module of the mobile station processing data transmitted from the second base station, the data transmission scheduling method comprising:
(a) the first base station data processing module of the mobile station receiving first data control information from the first base station;
(b) the first base station data processing module of the mobile station notifying the second base station data processing module of a data transmission time of the first data control information; and
(c) the second base station data processing module of the mobile station setting a base station listening status of the second base station data processing module as active according to the data transmission time.

12. The data transmission scheduling method of claim 11, wherein the first base station data processing module of the mobile station utilizes a first DRX configuration to receive data from the first base station, the method further comprising the following before the step (a):
(a1) the first base station data processing module of the mobile station notifying the second base station data processing module of the first DRX configuration;
wherein the step (c) further comprises:
(c1) the second base station data processing module of the mobile station setting the base station listening status of the second base station data processing module as active according to the data transmission time and the first DRX configuration.

13. The data transmission scheduling method of claim 11, further comprising the following after the step (c):
(d) the second base station data processing module of the mobile station receiving data from the second base station according to the result of the step (c).

14. The data transmission scheduling method of claim 11, wherein the mobile station receives the first data control information from the first base station via a physical downlink control channel.

15. A mobile station used in an LTE network system, the LTE network system further comprising a first base station, the mobile station connecting with the first base station and a second base station, the mobile station comprising:
a first base station data processing module, being configured to process data transmitted from the first base station; and
a second base station data processing module, being configured to process data transmitted from the second base station;
wherein the first base station data processing module receives first data control information from the first base station and notifies the second base station data processing module of a data transmission time of the first data control information, and the second base station data processing module sets a base station listening status of the second base station data processing module as active according to the data transmission time.

16. The mobile station of claim 15, wherein the first base station data processing module utilizes a first DRX configuration to receive data from the first base station and notifies the second base station data processing module of the first DRX configuration, and the second base station data processing module sets the base station listening status of the second base station data processing module as active according to the data transmission time and the first DRX configuration.

17. The mobile station of claim 15, wherein the second base station data processing module of the mobile station receives data from the second base station according to the result that the base station listening status is set as active.

18. The mobile station of claim 15, wherein the mobile station receives the first data control information from the first base station via a physical downlink control channel.

19. A data transmission scheduling method for a first base station, the first base station being used in an LTE network system, the LTE network system further comprising a mobile station, the mobile station connecting with the first base station and a second base station, a first base station data processing module of the mobile station processing data transmitted from the first base station, and a second base station data processing module of the mobile station processing data transmitted from the second base station, the data transmission scheduling method comprising:
(a) the first base station transmitting a data transmission time of first data control information to the second base station; and
(b) the first base station transmitting the first data control information to the mobile station so that the first base station data processing module of the mobile station notifies the second base station data processing module of the data transmission time of the first data control information and the second base station data processing module of the mobile station sets a base station listening status of the second base station data processing module as active according to the data transmission time.

20. A data transmission scheduling method for a first base station, the first base station being used in an LTE network system, the LTE network system further comprising a mobile station, the mobile station connecting with the first base station and a second base station, a first base station data processing module of the mobile station processing data transmitted from the first base station, and a second base station data processing module of the mobile station processing data transmitted from the second base station, the data transmission scheduling method comprising:
(a) the first base station receiving a data transmission time of first data control information from the second base station; and
(b) the first base station transmitting data to the mobile station according to the data transmission time of the first data control information of the second base station.
